(19) United States
(12) Patent Application Publication
(10) Pub. No.: US 2022/0250440 A1
(43) Pub. Date: Aug. 11, 2022

(54) HEATING STRUCTURE FOR A MOTOR VEHICLE

(71) Applicant: Valeo Systemes Thermiques, Le Mesnil Saint-Denis (FR)

(72) Inventors: Nicolas Devienne, Le Mesnil Saint-Denis (FR); Franck Martin, Le Mesnil Saint-Denis (FR); Alcina Tanghe, Le Mesnil Saint-Denis (FR)

(73) Assignee: Valeo Systemes Thermiques, Le Mesnil Saint-Denis (FR)

(21) Appl. No.: 17/623,824

(22) PCT Filed: Jun. 30, 2020
(86) PCT No.: PCT/FR2020/051143

§ 371 Date: Dec. 29, 2021

(30) Foreign Application Priority Data
Jul. 2, 2019 (FR) FR1907341

(51) Int. Cl. B60H 1/22; H05B 3/34

(52) U.S. Cl. CPC B60H 1/2227; H05B 2203/011; H05B 2203/006; H05B 3/342

(57) ABSTRACT

The invention relates to a heating structure (30) which is intended in particular to be installed inside a passenger compartment of a vehicle, the heating structure (30) comprising at least one resistive layer arranged to release heat when an electric current passes through this layer (36), this panel further comprising art electrode array comprising a plurality of contact electrodes (34) arranged to be in electrical contact with the resistive layer in order to Sallow electric current to flow through this resistive layer.

The present invention relates to a heating structure intended in particular to be installed inside a passenger compartment of a vehicle, this structure being in particular a radiant panel.

Generally, a radiant panel comprises a plurality of electrodes designed to provide heat through Joule heating by supplying an electric current to a conductive coating. Reference may be made, for example, to document US 2016/0059669 which describes such a radiant panel.

A radiant panel is a device generally comprising an electrical circuit designed to provide heat through Joule heating by supplying an electric current to resistive conductive elements. These may be filament elements or surface coatings. According to the existing literature, the conductive coating may for example be a paint layer comprising carbon particles and/or metallic particles. One problem found today is the difficulty of obtaining a homogeneous heating over the entire surface of the radiant panel, i.e. a heating temperature which does not vary from one point to another on the surface of the radiant panel. This drawback is compounded by geometric constraints since the radiant panel is intended to be arranged in different parts of the passenger compartment (headlining, door, pillar, glove compartment, etc.).

The object of the present invention is to provide improved radiant panels.

The present invention is thus a heating structure intended in particular to be installed inside a passenger compartment of a vehicle, this structure being in particular a radiant panel, the heating structure comprising at least one resistive layer arranged so as to release heat when an electric current passes through this layer, this structure further comprising an electrode array comprising a plurality of contact electrodes arranged so as to be in electrical contact with the resistive layer in order to allow electric current to flow through this resistive layer, wherein at least some of these contact electrodes are arranged with a spacing between successive electrodes which is variable.

It is known that the thermal power created through Joule heating depends on the supply voltage U and on the electrical resistance R between the two electrodes, here two contact electrodes, and follows the law: P=U²/R. The resistance R is proportional to the distance d between the two contact electrodes.

The applicant has found that the electrical consumption of each region of the resistive layer between two consecutive contact electrodes leads to a fall in voltage along the distribution electrode and hence along pairs of contact electrodes. Since the potential difference for these regions is linked to the power supplied by the region following the power formula P=U²/R, the heating structure provides less and less heating capacity along the pairs of contact electrodes. The invention may counter this phenomenon of heterogeneity of heating and provide homogeneous heating thanks to this mutual spacing between contact electrodes which is adapted so as to reduce the electrical resistance between two contact electrodes, and thus have a dissipated power which is as homogeneous as desired.

To obtain this homogeneity, the invention allows use of the same resistive coating or resistive layer, in particular the same conductivity, with the same thickness. This allows retention of the simple manufacturing process of the heating structure.

According to one aspect of the invention, at least some of the contact electrodes, in particular all of the contact electrodes of the electrode array, are mutually parallel.

According to one aspect of the invention, the electrode array comprises distribution electrodes arranged so as to conduct electric current from an electrical source to the contact electrodes, several contact electrodes being connected to one and the same distribution electrode.

According to one aspect of the invention, the at least one of the distribution electrodes is rectilinear over at least part of its length, and the contact electrodes associated with this distribution electrode are connected for example perpendicularly to this distribution electrode.

Naturally, the distribution electrodes may take different forms, in particular curved with roundings. The distribution electrodes may or may not be mutually parallel.

According to one aspect of the invention, the electrode array comprises at least two distribution electrodes which are mutually parallel over at least part of their length, and their associated contact electrodes are arranged between these two distribution electrodes and alternate with a mutual spacing which decreases in accordance with the decrease in voltage present between the pairs of electrodes, so as to maintain a substantially uniform electrical power between the pairs of contact electrodes.

According to one aspect of the invention, the contact electrodes which are arranged between two distribution electrodes (these contact electrodes forming part of one and the same group of contact electrodes) have only two spacing values or at least three or more spacing values.

According to one aspect of the invention, the resistive layer is a layer deposited on a substrate in particular by screen printing, this resistive layer extending in particular between the two distribution electrodes associated with the group of contact electrodes.

According to one aspect of the invention, the resistive layer comprises in particular carbon.

According to one aspect of the invention, the electrodes are made of conductive material, in particular metal, such as ink loaded with conductive particles, in particular particles of silver or copper. If desired, the electrodes are metallic adhesive strips, for example made of copper. Where applicable, these electrodes may also be made by deposition of a material on the substrate.

According to one aspect of the invention, the resistive layer associated with the group of contact electrodes is a continuous layer, or as a variant comprises a plurality of discrete resistive elements forming this layer.

According to one aspect of the invention, the contact electrodes of one and the same group have the same length.

According to one aspect of the invention, the heating structure comprises a substrate which carries the resistive layer and the electrodes. The substrate preferably has a thickness of less than 1 cm for a surface area of several cm² at least.

The invention furthermore concerns a component of a passenger compartment of a motor vehicle, in particular a component to be integrated into a vehicle door, or in particular parts of the dashboard, the footwell trim, the headlining, the armrest, comprising a heating structure, in particular a radiant panel, as described above.

According to one aspect of the invention, the passenger compartment component which comprises the heating structure, for example the radiant panel, is arranged to heat by thermal radiation (radiant panel) or by thermal conduction or thermal contact (contact heating structure), and not by convection heating, for example by heat carried by moving air. In particular, no air flow passes through the heating structure for cooling or heating of the passenger compartment. Preferably, the panel is disconnected from the air circulation system.

The heating structure and the HVAC system of the vehicle may if desired be controlled in coordinated fashion.

The component forms, for example, an element of a glove compartment or door panel of the vehicle, or the roof of the vehicle.

The invention furthermore concerns a heating structure having a resistive layer and electrodes for heating this layer, this structure being designed to be integrated into a passenger compartment component which comprises a decor element visible from the interior of the passenger compartment, this decor element being, for example, a trim element of the passenger compartment, such as for example a fabric, leather or aesthetic covering.

A further subject of the invention, independently or in combination with the foregoing, is a heating structure intended in particular to be installed inside a passenger compartment of a vehicle, this structure being in particular a radiant panel, the heating structure comprising at least one resistive layer arranged so as to release heat when an electric current passes through this layer, this structure further comprising an electrode array comprising a plurality of contact electrodes arranged so as to be in electrical contact with the resistive layer in order to allow electric current to flow through this resistive layer, the contact electrodes and the resistive layer are borne on a substrate made of a flexible material capable of taking a predetermined shape through deformation, this substrate being in particular also stretchable. In particular, the elements of the heating structure form a stretchable assembly, namely the substrate, the resistive layer and the contact electrodes are stretchable and flexible.

According to one aspect of the invention, the contact electrodes are formed by intermeshed, in particular woven or knitted, filaments, on or in a respectively woven or knitted substrate. The conductive filaments forming the contact electrodes are in contact with the resistive layer.

According to one aspect of the invention, the substrate is a non-woven. This non-woven may comprise a mixture of polypropylene fibers and/or polyester fibers. Other fibers may be used, for example natural fibers.

As a variant, the substrate is a fabric, in particular with stretchable filaments, or a knitted structure.

According to one aspect of the invention, the substrate may be a flexible plastic sheet or a foam such as TPU (thermoplastic polyurethane).

Advantageously, in order to remain substantially invisible and/or imperceptible, the contact electrodes and/or the resistive layer must be sufficiently thin, in particular with a thickness of less than 100 microns, and be flexible. These electrodes and the resistive layer may comprise a stretchable conductive ink and/or be inside the substrate.

According to one aspect of the invention, the resistive layer may comprise a stretchable resistive sheet, a resistive paint layer or a resistive ink. The resistive sheet is a sheet capable of releasing heat when an electric current passes through it.

According to one aspect of the invention, the conductive ink may be added to the substrate by screen printing, offsetting, inkjet printing, hot stamping and transfer, or electrodeposition.

According to one aspect of the invention, the substrate may be a decorative element of the passenger compartment, in particular an element visible to passengers in the passenger compartment. This type of decorative substrate may be chosen from: a leather or imitation leather substrate, containing in particular PVC, a textile which might or might not be of 3D type, or a decorative plastic film.

The invention also relates to a heating structure intended in particular to be installed inside a passenger compartment of a vehicle, this structure being in particular a radiant panel, the heating structure comprising a set of intermeshed filaments, certain filaments of which form heating conductive filaments arranged to give off heat when an electric current flows through these heating filaments.

In one exemplary embodiment of the invention, the substrate may be a stretchable textile which incorporates filaments as heating material. Alternatively, the substrate may be a stretchable textile or a stretchable knit which incorporates filaments used as contact electrodes and the resistive layer is placed on the surface. The resistive ink is attached, for example, to the textile by lamination, screen printing or hot stamping and transfer.

The substrate may be a knitted structure with at least one of the following filaments: non-stretchable filaments for the substrate, non-stretchable conductive filaments for electrodes, single-stranded or multi-stranded copper filaments, a copper conductive filament, and non-conductive filaments for reasons of mechanical strength or ease of manufacture.

The knitted structure has the advantage that, even if the support filament and the conductive filament which forms an electrode, for example, are not stretchable, the structure of the knit stitch makes the knitted structure stretchable. With a non-stretchable copper filament, the extensibility of the knit is about 14% for example.

According to one aspect of the invention, the heating structure comprises an electrical distribution circuit comprising distribution electrodes which carry the current from the connectors to the contact electrodes which are in contact, for example, with a resistive layer.

The contact and distribution electrodes are, for example, made of copper filaments.

When the substrate is woven, the stretchable characteristic may be obtained either through the arrangement of the woven structure, namely through the weaving technique, or through the intrinsic stretchability of the filaments used for the weaving.

In particular, if the extensibility of the conductive filament is different from that of the main fibers of the fabric, the end of each conductor must remain free to move inside or outside the fabric.

If a plurality of contact electrodes are connected together to one of the distribution electrodes, the connection between the distribution electrode and the contact electrodes may be made by integrating the distribution electrode into the weaving weft and the contact electrodes into the weaving warp or vice versa. By virtue of an alternating passage on the two sides of the woven structure, the connection between electrodes is secure.

In order to have a continuous manufacturing process for the knitted or woven structure, it is possible to connect the two sides of the contact electrodes to the distribution electrodes and then to electrically neutralize a portion of these contact electrodes with respect to the distribution electrode by cutting the filaments of the contact electrodes by stamping them in a stamped region, or by incorporating an electrical insulator at the location where the electrical connection is to be interrupted in an interrupted region.

Alternatively, it is possible to have a connector at the end of each contact electrode, or an external distribution electrode connecting all of the contact electrodes together.

The invention further relates to a method for manufacturing a heating structure, comprising the steps of weaving or knitting a substrate and of providing, on the substrate, heating or radiant regions formed by filaments woven or knitted with the substrate, or by depositing a resistive layer on the substrate.

The invention makes it possible, for example, to provide a heating structure forming a decorated part of a motor vehicle interior, this part being of complex shape. These complex surfaces may have curvatures along the axes in all three dimensions.

In a disadvantageous manner, not using the invention, the surface may be decorated with a layer of plastic film, leather or textile which makes any roughness or deficiency in the thickness of the surface visible. This leads to an impression of poor quality in the design of the part.

One problem with proceeding in this manner is that an interposition of a smoothing material between the heating structure and the decoration surface results in thermal insulation which reduces the temperature of the decoration surface and thus reduces the heating power provided to the passenger compartment environment.

The electrical power needed for sufficient heating power (for example higher than 500 W/m²) to give a positive feeling of comfort under a low voltage (for example lower than 50 volts) requires conductive lines of sufficient cross section which are difficult to conceal behind a decorative layer.

The invention makes it possible to have a heating structure that both exhibits a very low level of thickness defects and is stretchable so as to conform to the complex shape while remaining substantially imperceptible.

It is understood that the set of features and configurations above is in no way limiting. Further features, details and advantages of the invention will become more clearly apparent from reading the detailed description given below, and several exemplary embodiments that are given by way of non-limiting indication, with reference to the attached schematic drawings, in which:

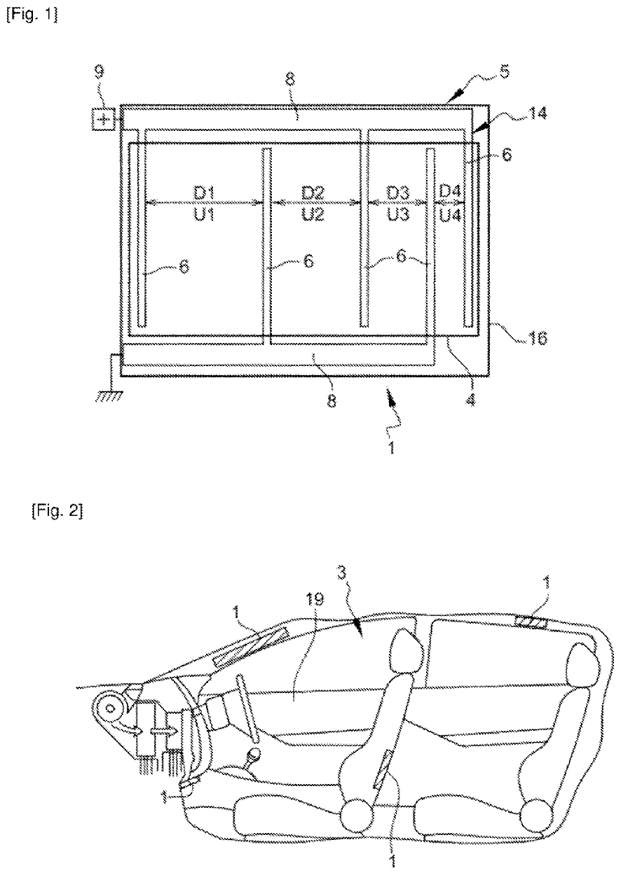

FIG. 1 is a schematic illustration of one exemplary embodiment of the radiant panel according to one exemplary embodiment of the invention;

FIG. 2 is a schematic illustration of components including the radiant panel of the invention;

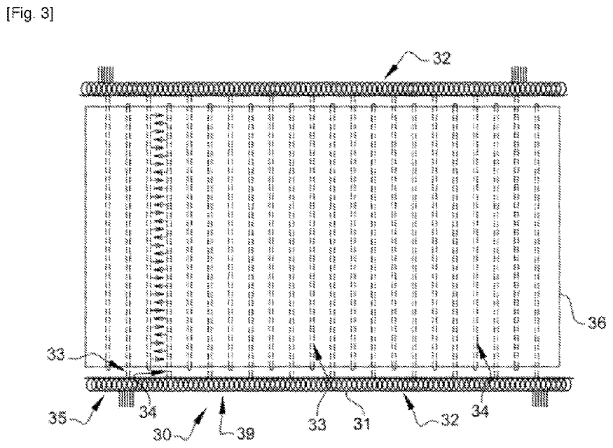

FIG. 3 is a schematic illustration of another heating structure of the invention;

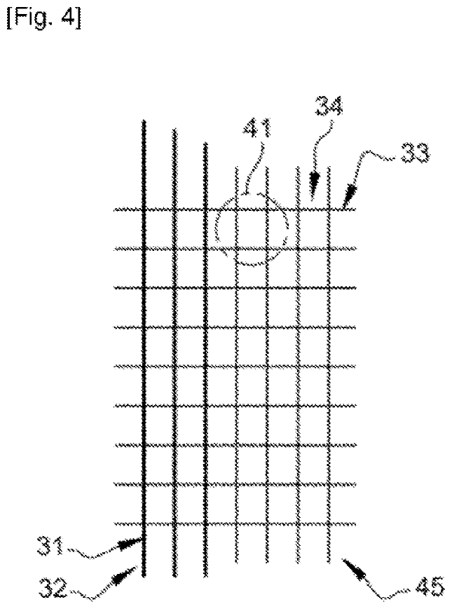

FIG. 4 is a schematic illustration of another heating structure of the invention;

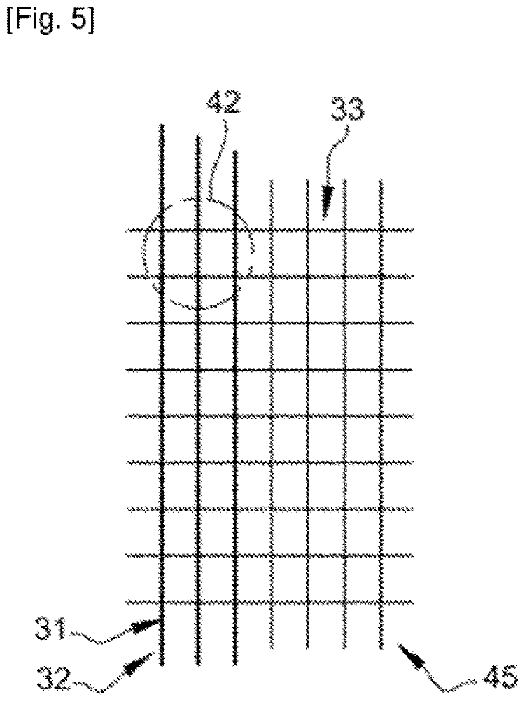

FIG. 5 is a schematic illustration of another heating structure of the invention.

FIG. 1 shows a radiant panel 1 forming a heating structure in the sense of the invention, and designed to be installed inside a passenger compartment 3 of a vehicle.

The radiant panel 1 comprises a resistive layer 4 which is designed to release heat when an electric current passes through this layer 4.

The resistive layer 4 is, for example, an acrylic paint loaded with conductive or semi-conductive particles. This conductive filler takes the form of carbon or graphite flakes for example.

This panel 1 also comprises an electrode array 5 comprising a plurality of contact electrodes 6 which are arranged to be in electrical contact with the resistive layer 4 in order to cause an electric current to flow through this resistive layer 4.

These contact electrodes 6 are arranged with a mutual spacing D1, D2, . . . Di between successive electrodes, which spacing is variable.

These contact electrodes 6 are rectilinear and mutually parallel in the example described.

The electrode array 5 comprises distribution electrodes 8 arranged to conduct electric current to the contact electrodes 6, wherein one of these electrodes 8 is connected to an electrical source 9, for example of positive electrical polarity. The other distribution electrode 8 is connected to another polarity, for example being connected to ground.

The electric current thus passes into a distribution electrode 8 which distributes it into the contact electrodes 6. The current then circulates in the resistive layer 4 before being collected by the contact electrodes 6 connected to the other distribution electrode 8.

Several contact electrodes 6 are connected to one and the same distribution electrode 8.

The distribution electrodes 8 are rectilinear over part of their length, even over their entire length, and the contact electrodes 6 associated with these distribution electrodes 8 are connected perpendicularly to this associated distribution electrode 8.

Here, the electrode array 5 comprises two mutually parallel distribution electrodes 8, and their associated contact electrodes 6 are arranged between these two distribution electrodes 8 and alternate with a spacing D1, D2 . . . Di, which decreases in accordance with the decrease in voltage U1, U2 . . . Ui present between the pairs of electrodes 6, so as to maintain a substantially uniform electrical power between the pairs of contact electrodes.

The contact electrodes 6 which are arranged between the two distribution electrodes 8 (these contact electrodes forming part of the same group 14 of contact electrodes) have a plurality of spacing values D1, D2, . . . Di. In the example described, D1>D2>D3>D4 and U1>U2>U3>U4 are for the voltages between the electrodes 6.

The resistive layer 4 is a layer deposited on a substrate 16, in particular by screen printing, this resistive layer 4 extending in particular between the two distribution electrodes 8 associated with the group of contact electrodes.

The electrodes 6 and 8 are made of conductive material, in particular metal, such as paint loaded with conductive particles, in particular particles of silver or copper.

In the example described, the resistive layer 4 associated with the group of contact electrodes is a continuous, substantially rectangular layer. Other shapes are naturally conceivable.

The contact electrodes 6 of one and the same group 14 have the same length. As a variant, the electrodes 6 may have different lengths.

In an example which is not shown, several pairs of distribution electrodes 8 may be provided, and there are then several groups 14 of contact electrodes 6.

A passenger compartment component 19 of a motor vehicle, in particular a component to be integrated into a door of the vehicle, is provided with a radiant panel 1. Several components may be provided in the passenger compartment.

The component 19 may comprise a decorative layer applied to the radiant panel. The decorative layer may for example be impermeable to air, for example being made of leather.

The distribution electrodes 8 may if desired have more complex shapes, with for example one or more rounded corners connecting the rectilinear portions.

In the example described, all spacing values Ui of a group 15 are different. As a variant, it is possible that certain spacing values of one and the same group are identical, and not all are different.

The substrate may be a sheet or a cloth for example.

The contact electrodes 6 and their associated distribution electrodes 8 are arranged in the manner of enmeshed combs.

In one variant, the heating structure is used in a component of a passenger compartment, being a passenger armrest, wherein the structure may warm the arm of the passenger through thermal contact.

In the example described, the substrate 16 is stretchable. In particular, the elements of the heating structure form a stretchable assembly, namely the substrate 16, the resistive layer 4 and the contact electrodes 6 are stretchable and flexible.

The contact electrodes 6 are formed by intermeshed, in particular woven or knitted, filaments, on a respectively woven or knitted substrate 16.

The conductive filaments forming the contact electrodes 6 are in contact with the resistive layer 4.

In another example of the invention, the substrate is a non-woven. This non-woven may comprise a mixture of polypropylene fibers and/or polyester fibers. Other fibers may be used, for example natural fibers.

As a variant, the substrate 16 is a fabric, in particular with stretchable filaments, or a knitted structure.

According to one aspect of the invention, the substrate may be a flexible plastic sheet or a foam such as TPU (thermoplastic polyurethane).

FIG. 3 shows a heating structure 30 intended in particular to be installed inside a passenger compartment of a vehicle, this structure being a radiant panel, the heating structure comprising a set of intermeshed filaments, of which certain filaments 31 form distribution electrodes 32, also called busbars, and other intermeshed filaments 33 form contact electrodes 34.

The substrate 35 on which the electrodes 32 and 34 are formed is here a knitted structure 35 which incorporates filaments used as contact electrodes and the resistive layer 36 is placed on the surface. The resistive ink is attached, for example, to the textile by lamination, screen printing or hot stamping and transfer.

The substrate 35 comprises at least one of the following filaments: non-stretchable filaments for the substrate, non-stretchable conductive filaments for electrodes, single-stranded or multi-stranded copper filaments, a copper conductive filament, and non-conductive filaments for reasons of mechanical strength or ease of manufacture.

The heating structure 30 comprises an electrical distribution circuit 39 comprising distribution electrodes 32 which carry the current from the connectors to the contact electrodes 34 which are in contact, for example, with a resistive layer.

The contact 34 and distribution 32 electrodes are, for example, made of copper filaments.

When the substrate 35 is knitted, the stretchable characteristic may be obtained either through the arrangement of the knitted structure, namely through the knitting technique, or through the intrinsic stretchability of the filaments used for the knitting.

In particular, if the extensibility of the conductive filament is different from that of the main fibers of the knit, the end of each conductor must remain free to move inside or outside the knit.

Let A be the number of contact electrodes 34 connecting to one of the distribution electrodes 32 and B the number of filaments used for each contact electrode; the distribution electrodes thus have A×B knitted filaments. The knitted filaments of the distribution electrodes are knitted so as to form connecting elements too.

In order to have a continuous manufacturing process for the knitted or woven structure, it is possible to connect the two sides of the contact electrodes 34 to the distribution electrodes 32 and then to electrically neutralize a portion of these contact electrodes with respect to the distribution electrode by cutting the filaments of the contact electrodes by stamping them, as represented by the regions 41 in FIG. 4, or by incorporating an electrical insulator into a region 42 illustrated in FIG. 5, at the location where the electrical connection must be interrupted. FIGS. 4 and 5 illustrate woven substrates 45.

It is possible to have a connector at the end of each contact electrode 36, or an external distribution electrode connecting all of the contact electrodes together.

The filaments used for the distribution electrodes have a larger diameter than the filaments used to form the contact electrodes, or heating filaments.

In the case of using heating filaments, it is not mandatory to have a resistive layer, for example a resistive ink layer.

If a plurality of contact electrodes 34 are connected together to one of the distribution electrodes 32, as illustrated in FIG. 3, the connection between the distribution electrode 32 and the contact electrodes 34 may be made by integrating the distribution electrode into the weaving weft and the contact electrodes into the weaving warp or vice versa. By virtue of an alternating passage on the two sides of the woven structure, the connection between electrodes is secure.

1. A heating structure to be installed inside a passenger compartment of a vehicle, the heating structure comprising:
at least one resistive layer arranged so as to release heat when an electric current passes through this layer;
an electrode array comprising a plurality of contact electrodes arranged so as to be in electrical contact with the resistive layer in order to allow electric current to flow through this resistive layer,
wherein the contact electrodes and the resistive layer are borne on a substrate made of a flexible material capable of stretching and taking a predetermined shape through deformation.

2. The heating structure as claimed in claim 1, wherein the contact electrodes are formed by intermeshed, woven or knitted filaments, on or in a respectively woven or knitted substrate.

3. The heating structure as claimed in claim 1, wherein the substrate is a non-woven substrate.

4. The heating structure as claimed in claim 1, wherein the substrate is a stretchable textile or stretchable knit which incorporates filaments used as contact electrodes and the resistive layer is placed on the surface.

5. The heating structure as claimed in claim 2, wherein, a plurality of contact electrodes being connected together to a distribution electrode, the connection between the distribution electrode and the contact electrodes may be made by integrating the distribution electrode into the weaving weft and the contact electrodes into the weaving warp or vice versa.

6. The heating structure as claimed in claim 1, wherein the contact electrodes and distribution electrodes are made of copper filaments.

7. A component forming an element of a glove compartment or a door panel of a vehicle, comprising: a heating structure as claimed in claim 1.
